(19) United States
(12) Patent Application Publication
(10) Pub. No.: US 2026/0221578 A1
(43) Pub. Date: Jul. 30, 2026

(54) CAP ASSEMBLY, SECONDARY BATTERY INCLUDING CAP ASSEMBLY, AND METHOD OF MANUFACTURING SECONDARY BATTERY

(71) Applicant: SAMSUNG SDI CO., LTD., Yongin-si (KR)

(72) Inventor: Jae Woong WI, Yongin-si (KR)

(21) Appl. No.: 19/278,991

(22) Filed: Jul. 24, 2025

(30) Foreign Application Priority Data
Jan. 24, 2025 (KR) 10-2025-0011233

(51) Int. Cl. H01M 50/325; H01M 10/0587; H01M 50/107; H01M 50/152

(52) U.S. Cl. CPC H01M 50/325; H01M 10/0587; H01M 50/107; H01M 50/152

(57) ABSTRACT

A cap assembly may include an upper cap having a first through-hole formed therein. A safety vent is positioned below the upper cap and has a second through-hole in fluid communication with the first through-hole. A lower cap is positioned below the safety vent and has a third through-hole. An insulator is positioned between the safety vent and the lower cap and having a groove formed therein that is in fluid communication with the third through-hole.

### CROSS-REFERENCE TO RELATED APPLICATION

[1] This application claims priority under 35 U.S.C. §119 to Korean Patent Application No. 10-2025-0011233, filed in the Korean Intellectual Property Office on January 24, 2025, the entire contents of which are hereby incorporated by reference.

### BACKGROUND

### Field

[2] Aspects of some embodiments are directed to a cap assembly, a secondary battery including the same, and a method of manufacturing a secondary battery.

### Description of the Related Art

[3] Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

[4] As one type of secondary battery, lithium ion batteries are widely used. When a lithium ion secondary battery is continuously left or used at a high temperature or is charged or discharged at a high current, internal gas may be generated due to deterioration of the cell and the like. The internal gas generated in the lithium ion secondary battery may lower the cell performance. Further, as the internal gas increases the internal pressure inside the case, there is a risk of ignition occurring if the external shape of the cell becomes deformed or if the internal electrode assembly is damaged.

[5] In some forms of secondary batteries, a vent component may be disposed in the secondary batteries to avoid such issues. The vent component has a function of discharging gas generated to outside of the secondary battery when the case reaches a certain pressure. When the internal pressure of the secondary battery is greater than a critical value, the connection between components is released and the current path is blocked, thereby preventing ignition and the like of the secondary battery.

[6] However, if gas is generated inside the secondary battery due to a high-temperature process during the battery formation process, the internal pressure of the secondary battery may rapidly reach a critical value, thereby causing the connection between components to be released. This has an effect of reducing the usability of the secondary battery.

[7] The above information disclosed in this Background section is for enhancement of understanding of the background of the present disclosure, and therefore, it may contain information that does not constitute related (or prior) art.

### SUMMARY

[8] An aspect of the present disclosure provides a cap assembly, a secondary battery including the cap assembly, and a method of manufacturing the secondary battery to solve the above technical issues.

[9] These and other aspects and features of the present disclosure will be described in or will be apparent from the following description of embodiments of the present disclosure.

According to an embodiment of the present disclosure, a cap assembly may include: a upper cap having a first through-hole formed therein; a safety vent below the upper cap, with the safety vent having a second through-hole formed therein that is in fluid communication with the first through-hole; a lower cap below the safety vent, with the lower cap having a third through-hole formed therein; and an insulator between the safety vent and the lower cap, the insulator having a groove formed therein that is in fluid communication with the third through-hole.

According to an embodiment, the first through-hole and the second through-hole may be in fluid communication with each other in a first direction, and the first through-hole and the second through-hole may be arranged on a line with at least a portion of the groove in the first direction.

According to an embodiment, the groove may be formed on a lower surface of the insulator, and the groove may have an arc shape about a center of the insulator.

According to an embodiment, a central angle of the groove may be 180-360 degrees.

According to an embodiment, the insulator may include at least one of polybutylene terephthalate (PBT) and polypropylene (PP).

According to an embodiment, the first through-hole, the second through-hole, and the third through-hole may have a cylindrical shape.

According to an embodiment, diameters of the first through-hole and the second through-hole may be the same.

According to an embodiment, the diameters of the first through-hole, the second through-hole, and the third through-hole may be greater than a width of the groove.

According to an embodiment, the first through-hole and the second through-hole may be located at the same azimuth angle relative to a central axis of the cap assembly, and the third through-hole may be located at a different azimuth angle relative to the central axis of the cap assembly.

According to an embodiment, when a contact portion of an upper surface of the insulator that is in contact with the second through-hole is penetrated, the groove may be in fluid communication with the first through-hole and the second through-hole.

According to an embodiment, a filler may be provided in at least a portion of the groove.

According to an embodiment, the filler may include a resin.

According to an embodiment of the present disclosure for solving the technical problem, a secondary battery may include: an electrode assembly; a cylindrical case accommodating the electrode assembly and having an opening on one side; and a cap assembly coupled to the case, wherein the cap assembly may include a upper cap having a first through-hole, a safety vent below the upper cap, with the safety vent having a second through-hole formed therein that is communication with the first through-hole, a lower cap below the safety vent, with a third through-hole formed in the lower cap, and an insulator between the safety vent and the lower cap, with the insulator having a groove formed therein that is in fluid communication with the third through-hole.

According to an embodiment, the first through-hole and the second through-hole may be in fluid communication with each other along a first direction, and the first through-hole and the second through-hole may be arranged on a line with at least a portion of the groove in the first direction.

According to an embodiment, the groove may be formed on a lower surface of the insulator, and the groove may have an arc shape about a center of the insulator.

According to an embodiment, when a contact portion of an upper surface of the insulator that is in contact with the second through-hole is penetrated, the groove may be in fluid communication with the first through-hole and the second through-hole.

According to an embodiment, a filler is provided in at least a portion of the groove.

According to an embodiment of the present disclosure for solving the technical problem, a method of manufacturing a secondary battery may include: preparing a secondary battery that includes an electrode assembly, a case that accommodates the electrode assembly and has an opening on one side, and a cap assembly coupled to the case; charging and discharging the secondary battery; penetrating the insulator of the secondary battery by inserting a pin into a first through-hole of the cap assembly and into a second through-hole that is in fluid communication with the first through-hole; and injecting a filler into the groove formed in the insulator by inserting an injector into the first through-hole and the second through-hole of the cap assembly.

According to an embodiment, penetrating the insulator may include using the pin to penetrate a contact portion of an upper surface of the insulator that is in contact with the second through-hole such that the groove is in fluid communication with the first through-hole and the second through-hole.

According to an embodiment, the filler may include a resin, and injecting the filler into the inside of the insulator may include injecting the filler into at least a portion of the groove through a penetrated contact portion and the second through-hole.

According to some embodiments of the present disclosure, it is possible to provide a cap assembly that may be used at high temperatures for a long time, a secondary battery including the cap assembly, and a method of manufacturing the secondary battery.

According to some embodiments of the present disclosure, when gas is generated inside the secondary battery during a high-temperature formation process, the cap assembly may discharge the internal gas to outside of the secondary battery and reseal the cap assembly so as to lower the internal pressure of the secondary battery.

According to some embodiments of the present disclosure, after the formation process, by lowering the internal pressure of the secondary battery, it is possible to extend the usage time of the secondary battery under high-temperature conditions.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a cross-sectional view of a secondary battery according to an embodiment of the present disclosure.

FIG. 2 is a perspective view a cross section of a cap assembly according to an embodiment of the present disclosure.

FIG. 3 is an exploded perspective view of a cross section of a cap assembly according to an embodiment of the present disclosure.

FIG. 4 is a perspective view of an insulator in which a groove having a central angle of 360 degrees is formed, according to an embodiment of the present disclosure.

FIG. 5 is a perspective view of an insulator in which a groove having a central angle of 180 degrees is formed, according to an embodiment of the present disclosure.

FIG. 6 is a cross-sectional view of a cap assembly before a contact portion is penetrated, according to an embodiment of the present disclosure.

FIG. 7 is an enlarged view of portion A of FIG. 6, illustrating penetration of a contact portion between the insulator and the second through-hole.

FIG. 8 is a cross-sectional view of a cap assembly after the contact portion is penetrated, according to an embodiment of the present disclosure.

FIG. 9 is an enlarged view of portion B of FIG. 8, illustrating injection of a filler through the penetrated contact portion.

FIG. 10 is a cross-sectional view of a cap assembly that includes a filler injected into the groove, according to an embodiment of the present disclosure.

FIG. 11 is a flowchart of a method of manufacturing a secondary battery according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being "on," "connected to," or "coupled to" another element or layer, it may be directly on, connected, or coupled to the other element or layer or one or more intervening elements or layers may also be present. When an element or layer is referred to as being "directly on," "directly connected to," or "directly coupled to" another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term "and/or" includes any and all combinations of one or more of the associated listed items. Further, the use of "may" when describing embodiments of the present disclosure relates to "one or more embodiments of the present disclosure." Expressions, such as "at least one of" and "any one of," when preceding a list of elements, modify the entire list of elements and do not modify the individual elements of the list. When phrases such as "at least one of A, B and C, "at least one of A, B or C," "at least one selected from a group of A, B and C," or "at least one selected from among A, B and C" are used to designate a list of elements A, B and C, the phrase may refer to any and all suitable combinations or a subset of A, B and C, such as A, B, C, A and B, A and C, B and C, or A and B and C. As used herein, the terms "use," "using," and "used" may be considered synonymous with the terms "utilize," "utilizing," and "utilized," respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as "beneath," "below," "lower," "above," "upper," and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as "below" or "beneath" other elements or features would then be oriented "above" or "over" the other elements or features. Thus, the term "below" may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms "a" and "an" are intended to include the plural forms as well, unless the context clearly indicates otherwise. It will be further understood that the terms "includes," "including," "comprises," and/or "comprising," when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all subranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any subrange subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being "the same" may mean that they are "substantially the same". Thus, the phrase "substantially the same" may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element "above (or below)" or "on (under)" another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly "coupled," "linked" or "connected" to each other, or another component may be "interposed" between the components".

Throughout the specification, when "A and/or B" is stated, it means A, B or A and B, unless otherwise stated. That is, "and/or" includes any or all combinations of a plurality of items enumerated. When "C to D" is stated, it means C or more and D or less, unless otherwise specified.

In the present disclosure, the layers and regions shown in the drawings may be exaggerated in dimension and relative size for clarity of explanation. That is, the sizes illustrated in the drawings are only for convenience, and the present disclosure is not limited thereto. In addition, throughout the specification, the same reference numerals designate the same components.

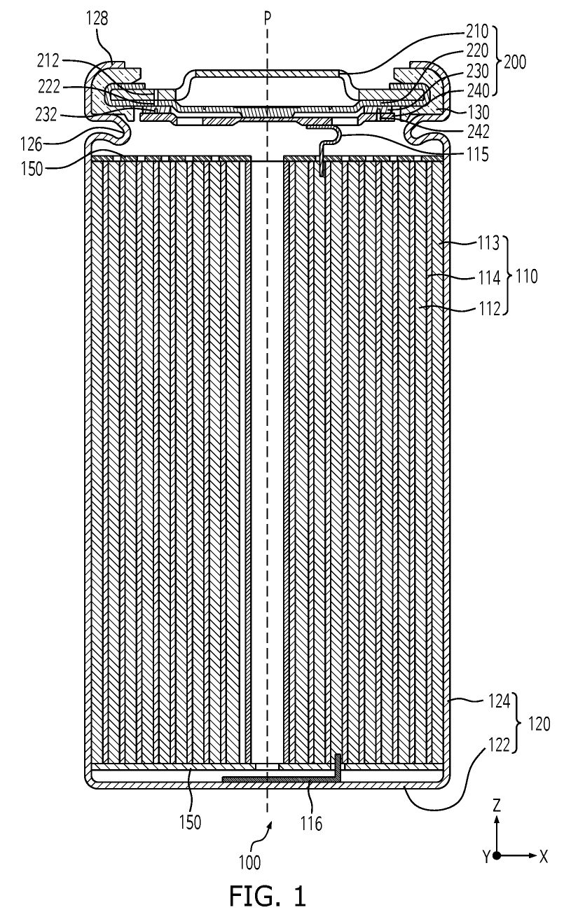

FIG. 1 is a cross-sectional view of a secondary battery according to an embodiment of the present disclosure.

Referring to FIG. 1, a secondary battery 100 may include an electrode assembly 110, a case 120 accommodating the electrode assembly 110 and an electrolyte, a cap assembly 200 coupled to an opening of the case 120 to seal the case 120, and an insulating plate 150 positioned between the electrode assembly 110 and the cap assembly 200 inside the case 120.

The electrode assembly 110 may include a separator 114, and a first electrode 112 and a second electrode 113 disposed with the separator 114 interposed therebetween. The electrode assembly may be wound in a jelly-roll form about a winding axis (P).

The first electrode 112 may include a first substrate and a first active material layer coated on the first substrate. A first lead tab 115 may extend outward from an uncoated portion of the first substrate where the first active material layer is not formed, and the first lead tab 115 may be electrically connected to the cap assembly 200.

The second electrode 113 may include a second substrate and a second active material layer coated on the second substrate. A second lead tab 116 may extend outward from an uncoated portion of the second substrate where the second active material layer is not formed, and the second lead tab 116 may be electrically connected to the case 120. The first lead tab 115 and the second lead tab 116 may extend in opposite directions.

The first electrode 112 may function as a positive electrode. In such an embodiment, the first substrate may be, for example, an aluminum foil, and the first active material layer may include, for example, a transition metal oxide. The second electrode 113 may function as a negative electrode. In such an embodiment, the second substrate may be, for example, a copper foil or a nickel foil, and the second active material layer may include, for example, graphite.

The separator 114 may prevent a short circuit between the first electrode 112 and the second electrode 113, while allowing the movement of lithium ions therebetween. The separator 114 may be made of, for example, a polyethylene film, a polypropylene film, or a polyethylene-polypropylene film.

The case 120 may accommodate the electrode assembly 110 and, together with the cap assembly 200, may form the external appearance of the secondary battery 100. The case 120 may include a substantially cylindrical body portion 124 and a bottom portion 122 connected to one end of the body portion 124. A beading part 126 that is deformed inwardly may be formed in the body portion 124, and a crimping part 128 bent inwardly may be formed at an open end of the body portion 124.

The beading part 126 may reduce or prevent movement of the electrode assembly 110 inside the case 120 and may facilitate seating of a gasket 130 and the cap assembly 200. The case 120 may be made of steel, a steel alloy, aluminum, or an aluminum alloy.

The cap assembly 200 may include a upper cap 210 having a first through-hole 212 formed therein. A safety vent 220 is positioned below the upper cap 210, with a second through-hole 222 being formed in the safety vent 220 that communicates with the first through-hole 212. A lower cap 240 is positioned below the safety vent 220 and a third through-hole 242 is formed in the lower ca 240. An insulator 230 is between the safety vent 220 and the lower cap 240, and a groove 232 is formed in the insulator 230 that communicates with the third through-hole 242. The cap assembly 200 may further include a gasket 130 formed to surround at least a portion of an edge of the safety vent 220. The gasket 130 may insulate the cap assembly 200 from the case 120. Herein, “communicates” refers to fluid communication such that, for example, a gas may pass from one hole to another hole that are in communication with each other.

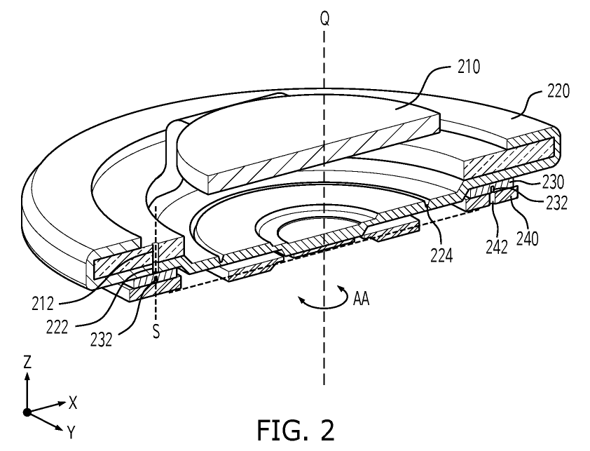

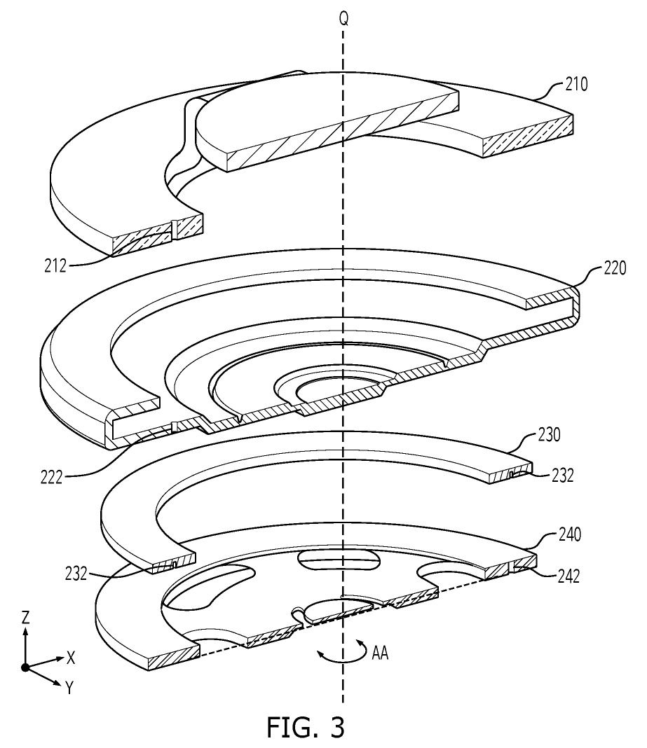

According to embodiments, the first through-hole 212 and the second through-hole 222 may communicate with each other along a first direction (i.e., along a Z-axis direction). The first through-hole 212 and the second through-hole 222 may be arranged on a line as at least a portion of the groove 232 along the first direction (the Z-axis direction). A more detailed description of this configuration will be provided below with reference to FIGS. 2 and 3.

The first through-hole 212 and the second through-hole 222 may be located at the same azimuth angle relative to a central axis of the cap assembly 200. The third through-hole 242 may be located at a different azimuth angle relative to the central axis of the cap assembly 200, as will be described in more detail below with reference to FIGS. 2 and 3.

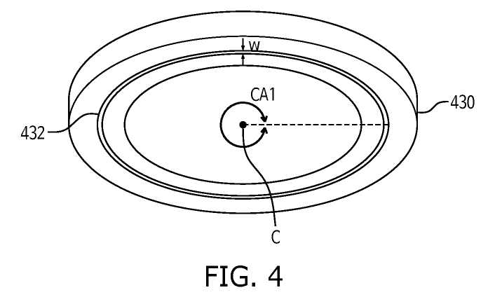

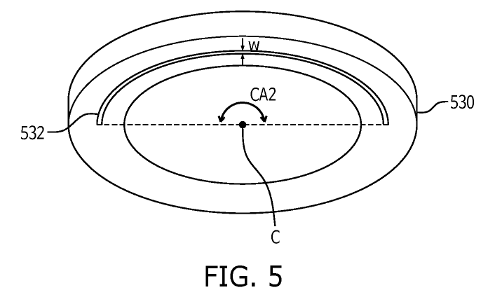

The groove 232 may be formed on a lower surface of the insulator 230. The groove 232 may have an arc shape about the center of the insulator 230 as a center point, as will be described in more detail below with reference to FIGS. 4 and 5.

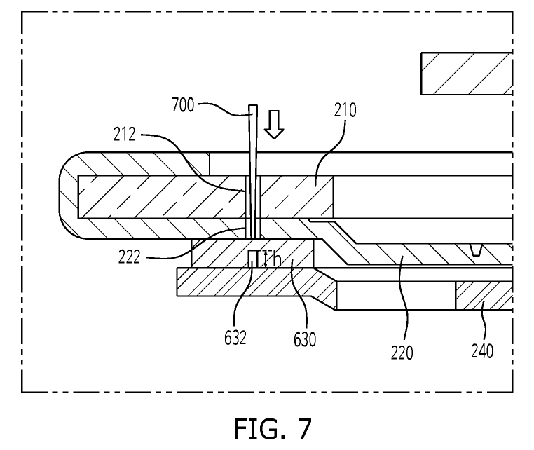

When a contact portion of an upper surface of the insulator 230 that is in contact with the second through-hole 222 is penetrated, the groove 232 may communicate with the first through-hole 212 and the second through-hole 222. The insulator 230 may further include a filler injected into at least a portion of the groove 232 through the penetrated contact portion with the second through-hole 222, as will be described in more detail below with reference to FIGS. 7 through 10.

To improve the performance and stability of the secondary battery and to ensure the lifespan thereof, a formation process may be carried out. The formation process may include charging and discharging to stabilize the chemical structure inside the secondary battery. According to the configuration of the cap assembly 200 described above, after the formation process, gas generated inside the secondary battery may be discharged through the through-holes 212, 222, 242 and the groove 232, and then the groove may be resealed. As a result, the usage time of the secondary battery under high-temperature conditions may be extended.

The insulating plate 150 may be positioned to be in contact with the electrode assembly 110 below the beading part 126. The insulating plate 150 may have a tab opening through which the first lead tab 115 is drawn out. The cap assembly 200, which is electrically connected to the first electrode 112 by the first lead tab 115, may face the electrode assembly 110 with the insulating plate 150 interposed therebetween and may remain insulated from the electrode assembly 110 by the insulating plate 150.

An electrolyte may be injected into the case 120. The electrolyte may allow lithium ions, which are generated by electrochemical reactions of a negative electrode plate and a positive electrode plate in the battery during charging/discharging, to move. Such an electrolyte may be a non-aqueous organic electrolyte that is a mixture of a lithium salt and a high-purity organic solvent. In another embodiment, the electrolyte may be a polymer using a polymer electrolyte or a solid electrolyte. But the present disclosure is not limited to these examples, and the type of the electrolyte is not limited thereto.

When the internal pressure of the secondary battery is greater than a critical value, the connection between parts in the cap assembly 200 may be released and the current path may be blocked, thereby preventing ignition of the secondary battery. However, if gas is generated inside the secondary battery due to a high-temperature process during the battery formation process, the internal pressure of the secondary battery may rapidly reach the critical value, causing the connection between components in the cap assembly 200 to be released. As a result, the usage time of the secondary battery may be reduced.

To solve this problem, after the formation process, it may be necessary to discharge gas generated inside the secondary battery to reduce the internal pressure of the secondary battery. When this done, under high-temperature conditions, the usage time of the cap assembly 200 and/or the secondary battery may be extended. The following describes in more detail the structure of the cap assembly 200 that can extend the usage time of the secondary battery.

FIG. 2 is a perspective view illustrating an example of a cross section of a cap assembly according to an embodiment of the present disclosure, and FIG. 3 is an exploded perspective view illustrating an example of a cross section of a cap assembly according to an embodiment of the present disclosure. FIGS. 2 and 3 show examples of the cap assembly 200 cut in half for explanation.

Referring to FIGS. 2 and 3, the cap assembly 200 may include a upper cap 210 having a first through-hole 212. A safety vent 220 is positioned below the upper cap 210 and having a second through-hole 222 that communicates with the first through-hole 212. A lower cap 240 is positioned below the safety vent 220 and has a third through-hole 242 formed therein. An insulator 230 is positioned between the safety vent 220 and the lower cap 240 and a groove 232 is formed in the safety vent 220 that communicates with the third through-hole 242. The cap assembly 200 shown in FIGS. 2 and 3 may correspond to the cap assembly 200 of the secondary battery 100 shown in FIG. 1.

The upper cap 210 may have a center portion protruding upward to form an electrode terminal that is electrically connected to an external device. The upper cap 210 may be a positive electrode terminal. The first through-hole 212 formed in the upper cap 210 may form a passage for discharging internal gas of the secondary battery to outside of the secondary battery. The upper cap 210 may be formed from aluminum or an aluminum alloy, but the present disclosure is not limited thereto.

The safety vent 220 may be located under the upper cap 210. The safety vent 220 may be in close contact, contact, engagement, or connection with the lower side of the upper cap 210. The safety vent 220 may be in close contact, contact, engagement, or connection with an edge of the upper cap 210, except for the center portion protruding upward from the upper cap 210. The second through-hole 222 formed in the safety vent 220 may form a passage for discharging the internal gas of the secondary battery to outside of the secondary battery. The safety vent 220 may be formed of aluminum or an aluminum alloy, but the present disclosure not limited thereto.

The safety vent 220 may further include a notch 224 formed to a certain depth on an upper surface. As a result, when the internal pressure of the secondary battery is greater than a reference pressure, the notch 224 may be broken by the internal gas, causing the internal gas of the secondary battery to be discharged to outside and thereby making the secondary battery safer. The safety vent 220 may be integrally formed with the upper cap 210 or formed separately from the upper cap 210.

The insulator 230 may be located between an edge of the safety vent 220 and an edge of the lower cap 240. When the safety vent 220 is deformed by the internal gas, the insulator 230 may insulate between the lower cap 240 and the safety vent 220. The groove 232 formed in the insulator 230 may form a passage for discharging internal gas to the outside when a contact portion with the second through-hole 222 is penetrated. After the gas is discharged, at least a portion of the groove 232 may be injected with a filler. The insulator 230 may include at least one of polybutylene terephthalate (PBT), polyethylene (PE), polypropylene (PP), and polyethylene terephthalate (PET). But the present disclosure is not limited to these examples.

The lower cap 240 may include a center portion, and the center portion may be electrically connected to the safety vent 220. The lower cap 240 may include a sub-plate at the center portion. Through the sub-plate, the lower cap 240 may be electrically connected to the safety vent 220. The sub-plate may be electrically connected to the electrode assembly 110. The sub-plate of the lower cap 240 may be welded and coupled to the safety vent 220. The third through-hole 242 formed in the lower cap 240 may form a passage for discharging internal gas of the secondary battery to outside of the secondary battery.

The first through-hole 212 and the second through-hole 222 may be in fluid communication with each other along a first direction (the Z-axis direction), and the first through-hole 212 and the second through-hole 222 may be arranged on the same line as at least a portion of the groove 232 along the first direction (the Z-axis direction). As a result of this arrangement, when a contact portion between an upper surface of the insulator 230 and the second through-hole 222 is penetrated, the groove 232 may be in fluid communication with the first through-hole 212 and the second through-hole 222.

The groove 232 may be formed on the lower surface of the insulator 230, and the groove 232 may be in an arc shape about the center of the insulator 230. For example, a central angle of the groove 232 may be 180-360 degrees. However, the central angle of the groove 232 is not limited thereto, and an the central angle may be other angles.

The first through-hole 212 and the second through-hole 222 may be located at the same azimuth angle relative to a central axis Q of the cap assembly 200. And the third through-hole 242 may be located at a different azimuth angle relative to the central axis Q of the cap assembly 200. For example, the third through-hole 242 may be located at an azimuth angle of 180 degrees relative to the first through-hole 212 and the second through-hole 222, based on the central axis Q of the cap assembly 200. With such an arrangement, the length of the groove 232 located between the first through-hole 212, the second through-hole 222, and the third through-hole 242 may be such that there is sufficient space in the groove 232 to inject a filler therein.

FIG. 4 is a perspective view of an insulator 430 in which a groove 432 having a central angle of 360 degrees is formed, and FIG. 5 is a perspective view of an insulator 530 in which a groove 532 having a central angle of 180 degrees is formed. The views shown in FIGS. 4 and 5 are from the bottom side of the insulators 430 and 530.

Referring to FIGS. 4 and 5, the shapes of the insulators 430 and 530 may be annular. An annular shape is such that there is an empty space in the center, and both the inner and outer boundaries are circular. The annular shape may have a width corresponding to the difference between the outer boundary and the inner boundary. Grooves 432 and 532 may be formed in the insulators 430 and 530, respectively. The grooves 432 and 532 may be formed on the lower surfaces of the insulators 430 and 530. The grooves 432 and 532 may be formed near the edges of the insulators 430 and 530. Thus, the grooves 432 and 532 may be in fluid communication with the third through-hole 242 (see FIG. 2).

The grooves 432 and 532 may have an arc shape with the center C of the insulators 430 and 530 as a center point. The inner boundary of the grooves 432 and 532 may be located outward of the inner boundary of the insulators 430 and 530, and the outer boundary of the grooves 432 and 532 may be located inward of the outer boundary of the insulators 430 and 530. The inward direction refers to a direction closer to the center C of the insulators 430 and 530, and the outward direction refers to a direction farther from the center C of the insulators 430 and 530. However, the shapes of the grooves 432 and 532 are not limited do the depicted embodiments, and the grooves may have various shapes in other embodiments.

The grooves 432 and 532 may have a certain width w. The inner boundary of the grooves 432 and 532 be spaced at a constant distance from the outer boundary of the grooves 432 and 532. As a result, the internal gas of the secondary battery may be discharged uniformly through the grooves 432 and 532. The certain width w of the grooves 432 and 532 may be set based on the size and shape of the secondary battery.

As shown in FIG. 4, the central angle CA1 of the groove 432 may be 360 degrees. That is, the groove 432 may be an annular shape formed continuously along the edge of the insulator 430. As a result, a sufficient internal space of the groove 432 may be secured for discharging the internal gas of the secondary battery. When manufacturing the cap assembly, the first through-hole 212, second through-hole 222, the third through-hole 242 (see FIG. 2) may be aligned or adjusted to correspond to the position of the groove 432.

As shown in FIG. 5, the central angle CA2 of the groove 532 may be 180 degrees. With such a configuration, the path through which the internal gas of the secondary battery moves may be shortened, so that it may be quickly discharged to the outside.

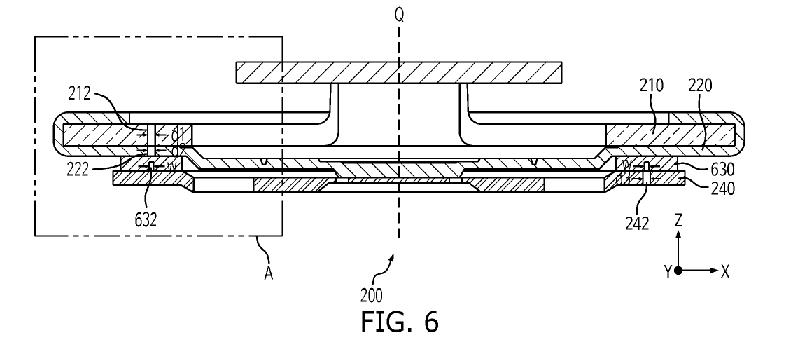

FIG. 6 is a cross-sectional view illustrating an example of a cap assembly before a contact portion is penetrated, according to an embodiment of the present disclosure.

Referring to FIG. 6, the first through-hole 212 and the second through-hole 222 may be in fluid communication with each other along a first direction (the Z-axis direction), and the first through-hole 212 and the second through-hole 222 may be arranged on the same line with at least a portion of the groove 632 along the first direction (the Z-axis direction). The third through-hole 242 may penetrate through the insulator 630, thereby communicating with the groove 632.

The first through-hole 212, the second through-hole 222, and the third through-hole 242 may have a cylindrical shape. Thus, a pin 700 (see FIG. 7) may be inserted into the first through-hole 212 and the second through-hole 222. However, the shapes of the first through-hole 212, the second through-hole 222, and the third through-hole 242 are not limited to cylindrical and may be various other shapes.

According to embodiments, the diameters d1 of the first through-hole 212 and d2 of the second through-hole 222 may be set so that the pin 700 can be inserted. For example, the diameters d1 of the first through-hole 212 and d2 of the second through-hole 222 may be the same as each other. In another example, the diameter d1 of the first through-hole 212 may be larger than the diameter d2 of the second through-hole 222, which allows the pin 700 to be inserted into the first through-hole 212 and the second through-hole 222.

The diameters d1 of the first through-hole 212 and d2 of the second through-hole 222 may be based on the diameter of the pin 700. The diameters d1of the first through-hole 212 and d2 of the second through-hole 222 may be larger than the diameter of the pin 700 so that the pin 700 can be inserted into the holes 212 and 222. For example, if the groove 632 has a certain width w, the diameters d1 of the first through-hole 212 and d2 of the second through-hole 222 may be larger than the width of the groove 632. As a result, the pin 700 may be inserted into the first through-hole 212 and the second through-hole 222.

The diameter d3 of the third through-hole 242 may be set so that the internal gas of the secondary battery can be discharged through the third through-hole 242. For example, if the groove 632 has a certain width w, the diameter d3 of the third through-hole 242 may be larger than the width w of the groove 632. As a result, the internal gas of the secondary battery may flow from the third through-hole 242 to the groove 632.

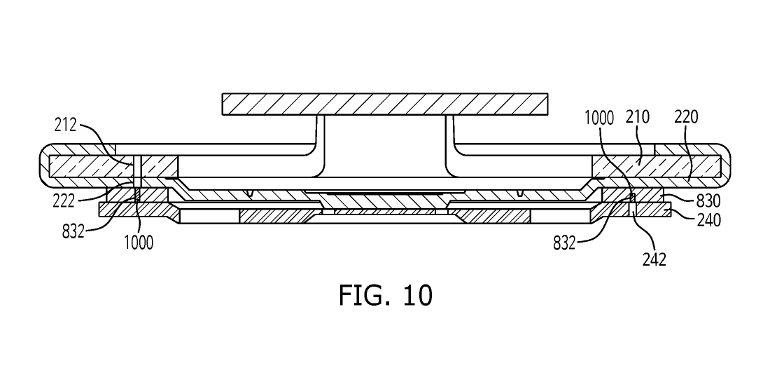

The first through-hole 212 and the second through-hole 222 may be located at the same azimuth angle relative to the central axis Q of the cap assembly 200. And the third through-hole 242 may be located at a different azimuth angle relative to the central axis Q of the cap assembly 200. For example, the third through-hole 242 may be positioned at an azimuth angle of 180 degrees relative to the first through-hole 212 and the second through-hole 222, based on the central axis Q of the cap assembly 200. That is, the third through-hole 242 may be positioned in the opposite direction to the first through-hole 212 and the second through-hole 222, based on the central axis Q of the cap assembly 200. As a result, the length of the groove 232 located between the first through-hole 212, the second through-hole 222, and the third through-hole 242 may increase such that there is sufficient space in the groove 232 to inject a filler 1000 (see FIG. 10). And, thus, the sealing performance of the cap assembly 200 may be improved.

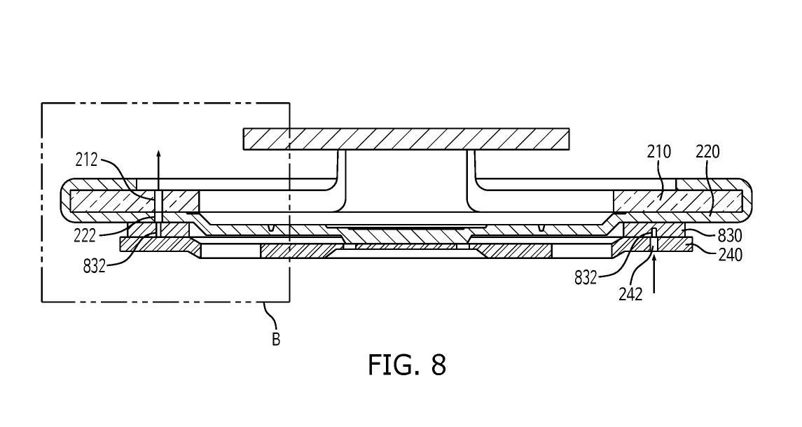

FIG. 7 is an enlarged view of portion A of FIG. 6, illustrating penetration of a contact portion between the insulator and the second through-hole, and FIG. 8 is a cross-sectional view of a cap assembly after the contact portion is penetrated, according to an embodiment of the present disclosure.

Referring to FIG. 7, the pin 700 may be inserted into the first through-hole 212 and the second through-hole 222. The pin 700 may then press on the contact portion between the upper surface of the insulator 630 and the second through-hole 222.

The pin 700 may have a slender cylindrical rod shape with a pointed tip at the end. Thus, the pin 700 may be inserted into the first through-hole 212 and the second through-hole 222. The pin 700 may be formed from a material with high durability to penetrate the contact portion between the upper surface of the insulator 630 and the second through-hole 222. For example, the pin 700 may be formed from a metal or a plastic material. But the present disclosure is not limited to metal or plastic material.

The depth h of the groove 632 may be set so that the insulator can be penetrated by the pin 700. In an example, the depth h of the groove 632 may be greater than half the thickness of the insulator 630. In specific examples, the depth h of the groove 632 may be 2 mm to 3 mm. As a result, the contact portion between the upper surface of the insulator 630 and the second through-hole 222 may be penetrated by the pin 700. However, the depth h of the groove 632 is not limited to the specific example and may be formed with various other depths.

Referring to FIG. 8, when the contact portion between the upper surface of the insulator 830 and the second through-hole 222 is penetrated, fluid communication is established between the groove 832 and the first through-hole 212 and the second through-hole 222. As a result, if gas is generated inside the secondary battery during the battery formation process, the gas generated inside the secondary battery may move to the groove 832 through the third through-hole 242. Thereafter, when the groove 832 is in fluid communication with the first through-hole 212 and the second through-hole 222, the gas that has moved into the groove 832 may be discharged through the first through-hole 212 and the second through-hole 222.

With the configuration of the grooves 632 and 832 described above, after the battery formation process, the internal pressure of the secondary battery may be reduced by discharging the gas generated inside the secondary battery. Accordingly, under high-temperature conditions, the usage time of the cap assembly and/or the secondary battery may be extended.

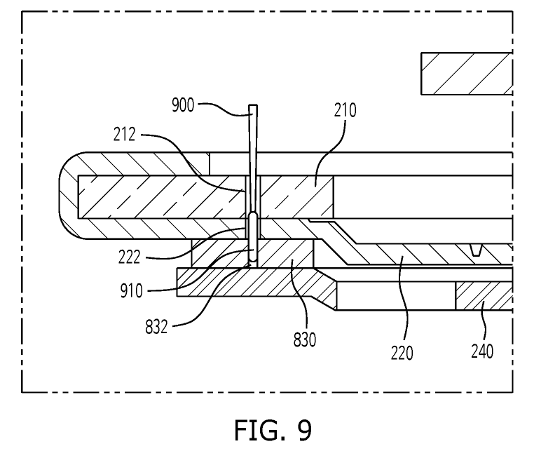

FIG. 9 is an enlarged view of portion B of FIG. 8, illustrating the injection of a filler through the penetrated contact portion, and FIG. 10 is a cross-sectional view illustrating an example of a cap assembly that further includes a filler injected into the groove.

Referring to FIG. 9, an injector 900 may be inserted into the first through-hole 212 and the second through-hole 222 to inject a filler 910 into the groove 832 formed in the insulator 830. The injector 900 may inject the filler 910 into at least a portion of the groove 832 through the penetrated contact portion between the upper surface of the insulator 830 and the second through-hole 222.

Referring to FIG. 10, the insulator 830 may further include a filler 1000 injected into at least a portion of the groove 832 through the penetrated contact portion with the second through-hole 222. The filler 1000 thereby seals the groove 832 to thereby produce a secondary battery with reduced internal pressure.

According to embodiments, the filler 1000 may include a resin. The resin may be composed of a synthetic material in the form of a highly viscous liquid or solid. Also, the resin may harden under certain conditions to exhibit strong adhesion and sealing functions. The material of the resin may be set with consideration of adhesion, durability, and ease of processing. For example, the filler 1000 may include at least one of an epoxy resin, a polyurethane resin, a polyester resin, and an acrylic resin. The material of the filler 1000 may also be based on the material of the insulator 830. For example, the filler 1000 may include at least one of a polymer material such as polybutylene terephthalate (PBT) or polypropylene (PP), or silicone material. As a result, the filler 1000 may strongly adhere to the groove 832 and reliably seal the insulator 830.

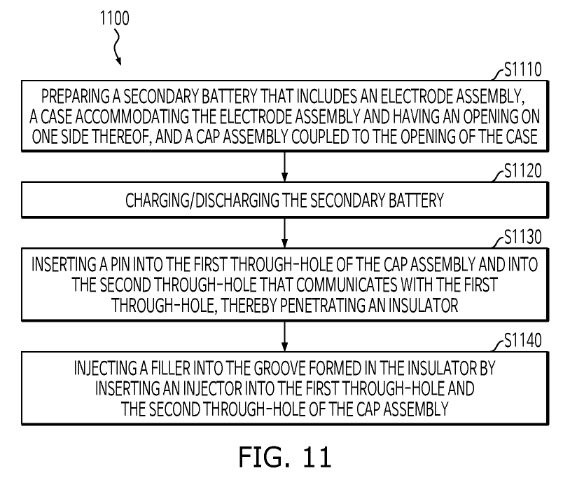

FIG. 11 is a flowchart of a method of manufacturing a secondary battery according to an embodiment of the present disclosure.

Referring to FIG. 11, a method 1100 of manufacturing a secondary battery may begin by preparing a secondary battery that includes an electrode assembly, a case accommodating the electrode assembly and having an opening on one side thereof, and a cap assembly coupled to the case (S1110). The cap assembly may include a upper cap having a first through-hole, a safety vent below the upper cap and having a second through-hole in fluid communication with the first through-hole, a lower cap below the safety vent and having a third through-hole, and an insulator between the safety vent and the lower cap and having a groove formed therein that is in fluid communication with the third through-hole. The first through-hole and the second through-hole may be in fluid communication with each other along a first direction, and the first through-hole and the second through-hole may be arranged on the line as at least a portion of the groove along the first direction. The first through-hole and the second through-hole may be located at the same azimuth angle relative to a central axis of the cap assembly. The third through-hole may be located at a different azimuth angle relative to the central axis of the cap assembly. In an embodiment, the groove may be formed on a lower surface of the insulator. The groove may have an arc shape about the center of the insulator as a center point.

Next, the secondary battery may be charged and discharged (S1120). The charging and discharging of the secondary battery may be referred to as a formation process. The formation process may be carried out to improve the performance and stability of the secondary battery and to ensure the lifespan of the secondary battery. Gas may be generated inside the secondary battery by the formation process.

Then, by inserting a pin into the first through-hole of the cap assembly and into the second through-hole that is in fluid communication with the first through-hole, the insulator may be penetrated (S1130). In embodiments, the step (S1130) of penetrating the insulator may include using the pin to penetrate a contact portion of the upper surface of the insulator that is in contact with the second through-hole such that the groove communicates with the first through-hole and the second through-hole. When the contact portion between the upper surface of the insulator and the second through-hole is penetrated, the groove may be in fluid communication with the first through-hole and the second through-hole. As a result, if gas is generated inside the secondary battery by the formation process, the gas generated inside the secondary battery may move to the groove through the third through-hole. Thereafter, when the groove is in fluid communication with the first through-hole and the second through-hole, the gas that has moved into the groove may be discharged through the first through-hole and the second through-hole.

Finally, by inserting an injector into the first through-hole and the second through-hole of the cap assembly, a filler may be injected into the groove formed in the insulator (S1140). The filler may include a resin, and the step (S1140) of injecting the filler into the inside of the insulator may include injecting the filler into at least a portion of the groove through a penetrated contact portion with the second through-hole. The filler may include a resin, and the resin may be a synthetic material in the form of a highly viscous liquid or solid. Also, the resin may harden under certain conditions to exhibit strong adhesion and sealing functions. The material of the resin may be set with consideration of adhesion, durability, and ease of processing. For example, the filler may include at least one of an epoxy resin, a polyurethane resin, a polyester resin, and an acrylic resin. Also, the material of the filler may be set with consideration of the material of the insulator. For example, the filler may include at least one of a polymer material such as polybutylene terephthalate (PBT) or polypropylene (PP), or silicone material. Thus, the filler may strongly adhere to the groove and reliably seal the insulator.

The flowchart of FIG. 11 and the above description are merely one example of the present disclosure, and the scope of the present disclosure is not limited thereto. For example, one or more steps of the flowchart and the above description may be added, changed, or deleted, the order of one or more steps may be changed, or one or more steps may be performed simultaneously.

Although the present disclosure has been described above with reference to embodiments thereof, the present disclosure is not limited thereto. Various modifications and variations can be made by those skilled in the art within the spirit of the present disclosure.

### DESCRIPTION OF SOME REFERENCE SYMBOLS

100: secondary battery

110: electrode assembly

120: case

130: gasket

150: insulating member

200: cap assembly

210: upper cap

212: first through-hole

220: safety vent

222: second through-hole

230: insulator

232: groove

240: lower cap

242: third through-hole

700: pin

900: injector

1000: filler

What is claimed is:

1. A cap assembly, comprising:
a upper cap having a first through-hole formed therein;
a safety vent below the upper cap, with the safety vent having a second through-hole formed therein that is in fluid communication with the first through-hole;
a lower cap below the safety vent, with a third through-hole formed in the lower cap; and
an insulator between the safety vent and the lower cap, with the insulator having a groove formed therein that is in fluid communication with the third through-hole.

2. The cap assembly according to claim 1, wherein the first through-hole and the second through-hole are in fluid communication with each other in a first direction, and
wherein the first through-hole and the second through-hole are arranged on a line with at least a portion of the groove in the first direction.

3. The cap assembly according to claim 1, wherein the groove is formed on a lower surface of the insulator, and the groove has an arc shape about a center of the insulator.

4. The cap assembly according to claim 3, wherein a central angle of the groove is 180-360 degrees.

5. The cap assembly according to claim 1, wherein the insulator comprises at least one of polybutylene terephthalate (PBT) and polypropylene (PP).

6. The cap assembly according to claim 2, wherein the first through-hole, the second through-hole, and the third through-hole have a cylindrical shape.

7. The cap assembly according to claim 6, wherein diameters of the first through-hole and the second through-hole are the same.

8. The cap assembly according to claim 6, wherein diameters of the first through-hole, the second through-hole, and the third through-hole are greater than a width of the groove.

9. The cap assembly according to claim 1, wherein the first through-hole and the second through-hole are located at the same azimuth angle relative to a central axis of the cap assembly, and the third through-hole is located at a different azimuth angle relative to the central axis of the cap assembly.

10. The cap assembly according to claim 1, wherein, when a contact portion of an upper surface of the insulator that is in contact with the second through-hole is penetrated, the groove is in fluid communication with the first through-hole and the second through-hole.

11. The cap assembly according to claim 10, wherein a filler is provided in at least a portion of the groove.

12. The cap assembly according to claim 11, wherein the filler comprises a resin.

13. A secondary battery, comprising:
an electrode assembly;
a cylindrical case accommodating the electrode assembly and having an opening on one side thereof; and
a cap assembly coupled to the case,
wherein the cap assembly comprises:
a upper cap having a first through-hole formed therein;
a safety vent below the upper cap, with the safety vent having a second through-hole formed therein that is in fluid communication with the first through-hole;
a lower cap below the safety vent, with a third through-hole formed in the lower cap; and
an insulator between the safety vent and the lower cap, with the insulator having a groove formed that is in fluid communication with the third through-hole.

14. The secondary battery according to claim 13, wherein the first through-hole and the second through-hole are in fluid communication with each other along a first direction, and
wherein the first through-hole and the second through-hole are arranged on a line with at least a portion of the groove in the first direction.

15. The secondary battery according to claim 13, wherein the groove is formed on a lower surface of the insulator, and the groove has an arc shape about a center of the insulator.

16. The secondary battery according to claim 13, wherein, when a contact portion of an upper surface of the insulator that is in contact with the second through-hole is penetrated, the groove is in fluid communication with the first through-hole and the second through-hole.

17. The secondary battery according to claim 16, wherein a filler is provided in at least a portion of the groove.

18. A method of manufacturing a secondary battery, the secondary battery comprising an electrode assembly, a case accommodating the electrode assembly and having an opening on one side thereof, and a cap assembly coupled to the case, the method comprising:
preparing the secondary battery;
charging and discharging the secondary battery;
penetrating an insulator of the secondary battery by inserting a pin into a first through-hole of the cap assembly and into a second through-hole that is in fluid communication with the first through-hole; and
injecting a filler into a groove formed in the insulator by inserting an injector into the first through-hole and the second through-hole of the cap assembly,
wherein the cap assembly comprises:
an upper cap having a first through-hole formed therein;
a safety vent below the upper cap and having a second through-hole in fluid communication with the first through-hole;
a lower cap below the safety vent and having a third through-hole formed therein; and
an insulator between the safety vent and the lower cap, the insulator having a groove in fluid communication with the third through-hole.

19. The method of manufacturing a secondary battery according to claim 18, wherein penetrating the insulator comprises using the pin to penetrate a contact portion of an upper surface of the insulator that is in contact with the second through-hole such that the groove becomes in fluid communication with the first through-hole and the second through-hole.

20. The method of manufacturing a secondary battery according to claim 19, wherein the filler comprises a resin, and injecting the filler into the insulator comprises injecting the filler into at least a portion of the groove through a penetrated contact portion and the second through-hole.
